(19) United States
(12) Patent Application Publication
(10) Pub. No.: US 2008/0070020 A1
(43) Pub. Date: Mar. 20, 2008

(54) Net Material

(75) Inventors: Samuel Keith Black, Raleigh, NC (US); Jody Anne Erickson, Morrisville, NC (US); Scott Gallinger, Raleigh, NC (US); Betsy Simmons, Creedmore, NC (US); Terezie Zapletalova, Raleigh, NC (US); Jean Skinner, Wake Forest, NC (US); Jeff Stine, Wake Forest, NC (US)

Correspondence Address: GROSSMAN, TUCKER, PERREAULT & PFLEGER, PLLC, 55 SOUTH COMMERICAL STREET, MANCHESTER, NH, 03101, US

(73) Assignee: Freudenberg Nonwovens, L.P., Durham, NC (US)

(21) Appl. No.: 11/855,749

(22) Filed: Sep. 14, 2007

Related U.S. Application Data
(60) Provisional application No. 60/825,706, filed on Sep. 14, 2006.

(51) Int. Cl. B32B 5/02; B29C 59/04

(52) U.S. Cl. 428/219; 264/119; 442/125

(57) ABSTRACT

The present disclosure relates to a nonwoven insect barrier net. The nonwoven insect barrier may be formed into a net structure for use over and/or surrounding a sleeping surface. The nonwoven insect barrier net may inhibit insects from penetrating the area within the net structure. The insect barrier may be formed from a nonwoven material and an insect repellant composition.

### CROSS-REFERENCE TO RELATED APPLICATIONS

The present application claims the benefit of U.S. Provisional Application Ser. No. 60/825,706, filed Sep. 14, 2006, the teachings of which are incorporated herein by reference.

### FIELD OF INVENTION

The present disclosure relates to a nonwoven insect barrier net. In particular, the present invention relates to a nonwoven insect barrier that may be formed into a net structure. The net structure may then be used over a sleeping surface to inhibit various insects from entering the area within the net structure.

### BACKGROUND

The CDC has named malaria one of the leading causes of death worldwide, particularly in many developing countries. The World Health Organization reported in its 2005 World Malaria Report that between 350 and 500 million clinical episodes of malaria occur every year, causing at least one million deaths. Those most affected by malaria are young children, pregnant women and travelers who live in areas where there is little to no malaria transmission.

Malaria, like other diseases such as Chagas, dengue, leishmaniasis, lymphatic filariasis, and African trypanosomiosis may be spread through the human population via insects and rodents. To protect against the spread of these diseases, various precautions may be taken including the use of mosquito nets, screens, pesticides, protective clothing and combinations thereof. For example, mosquito nets are commonly used to protect against nighttime mosquito bites.

Such mosquito nets may often be produced by warp knitting. The nets may be treated with insecticides, commonly referred to as ITN's (insecticide treated nets), which not only provide a physical barrier against mosquitoes and other insects but may also provide a chemical barrier. In addition to ITN's, long lasting insecticide nets (LLIN's) have been produced including an insecticide which may be pre-applied onto the nets in roll form or after sewing the nets into a desired form. Such pre-applications may be applied by spray, pad, dip coating or incorporated into the fibers. The insecticide treated nets may last between a few to 20 or more washes before requiring re-application of the insecticide.

### SUMMARY

An aspect of the present disclosure relates to a nonwoven insect barrier net. The insect barrier net may include a nonwoven including fibers having a denier less than 50 and an inset repellant disposed on or incorporated in the fibers. The nonwoven material may also have an air permeability of at least 1500 l/m²/second. The nonwoven material may also have bicomponent fibers with a denier less than 50.

Another aspect of the present invention relates to a method of making a nonwoven insect barrier net material. The method may include providing fibers with a denier less than 50, depositing the fibers on a moving belt forming a nonwoven with a basis weight less than 50 g/m² and bonding the nonwoven using heat and pressure. The nonwoven may then be collected and formed into a nonwoven insect barrier net. In addition, an insect repellent composition may be applied to the nonwoven insect barrier net.

A further aspect of the present invention relates to a nonwoven insect barrier net, wherein a nonwoven includes bicomponent fibers. The fibers may have a denier of less than 10. In addition, the nonwoven may have a basis weight of less than 50 grams per square meter, an air permeability of at least 2000 l/m²/second and an apparent pore size opening less than 5 mm. Deltamethrin may be disposed on or incorporated in the fibers at a level of at least 25 mg per square meter of the nonwoven.

### BRIEF DESCRIPTION OF THE DRAWINGS

The above-mentioned and other features and advantages this disclosure, and the manner of attaining them, will become more apparent and the disclosure may be better understood by reference to the following description of embodiments of the invention taken in conjunction with the accompanying drawings.

FIG. 1 is a plan view of a rectangular embodiment of the present disclosure.

FIG. 2 is a top view of a rectangular embodiment of the present disclosure.

FIG. 3 is a plan view of a conical embodiment of the present disclosure.

FIG. 4 is a top view of a conical embodiment of the present disclosure.

### DETAILED DESCRIPTION

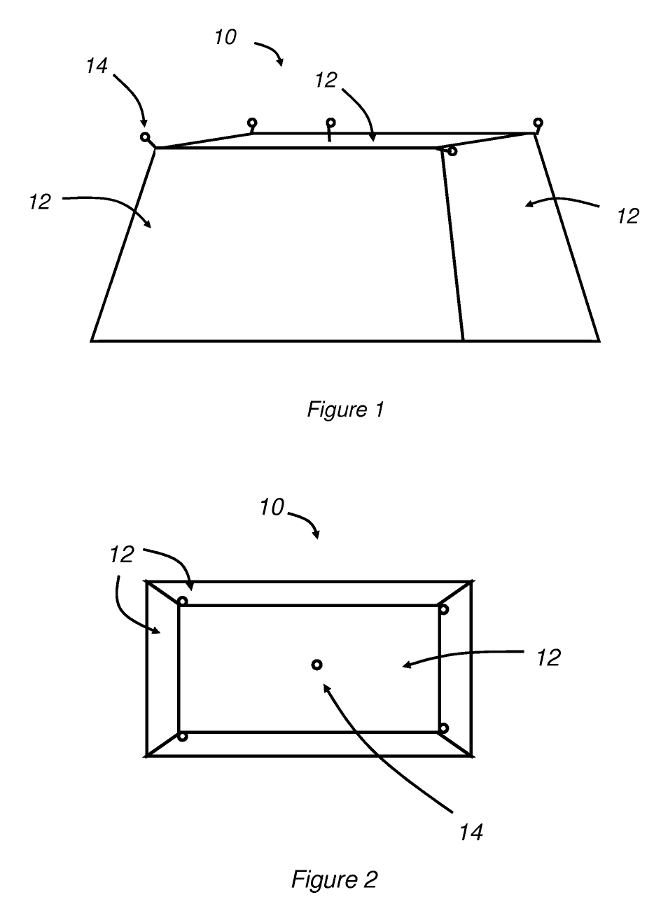

The present disclosure relates to an insect barrier net structure suitable for being placed over a sleeping surface. At least two mechanisms may be employed to inhibit insect penetration into the area contained within the net structure, which may include a nonwoven material and an insect barrier composition. The nonwoven material may be useful in creating a permeable, light-weight, high-strength physical barrier. The insect barrier composition may contribute to the physical barrier by discouraging insect approach and penetration of the nonwoven material. The nonwoven material may be formed into a variety of net structures that may be suitable to be placed over a sleeping surface. The net structure contemplated herein may be a rectangular tent structure, or a conical net structure as illustrated in FIGS. 1-4, which illustrate exemplary embodiments described herein. It should be appreciated, however, that other structures may be utilized as well, such as circular structures, square structures and various other configurations.

The nonwoven material may be described as a structure where individual fibers or continuous filaments are randomly orientated and subsequently bonded together through a variety of known mechanisms. The resultant material may be neither woven nor knit, as those terms are known in the art. The net may incorporate a nonwoven material in a variety of forms such as a carded thermally bonded material, a carded binder-bonded material, an air-laid thermally bonded material, an air-laid binder bonded material or a carded needle punched material. An exemplary nonwoven material may include, for example, a spunbond fabric. A spunbond fabric may be understood herein as including filaments or fibers which may be extruded, drawn and laid on a moving belt to form a web. The spunbond fabric may then be bonded via a number of bonding methods, such as by chemical, thermal, mechanical, ultrasonic or a combination thereof.

Accordingly, in an exemplary embodiment, the filaments may be formed from a thermoplastic material, such as polyester, co-polyester, polypropylene, polyethylene and polyamide, or a combination thereof. The material may be fed into an extruder and may be extruded through a spinning die. The fibers may then be drawn into filaments which may be in the range of about 0.1 to 50 denier, including all values and increments therein, such as 1-10 denier, 25 denier, 15 denier, etc. The filaments or fibers may be of various cross-sectional shapes including round, hollow, trilobal, ribbon, etc. It should be appreciated that the fibers may also include more than one polymeric material. In such a manner the fibers may be bi-component or multiple-component fibers assuming various cross-sectional configurations such as sheath/core, segmented pie, segmented ribbon, side-by-side, island-in-sea, etc. In one exemplary embodiment, a sheath/core bicomponent fiber may be employed. In a further embodiment, the sheath polymer of the sheath/core configuration may act a binding site for an insect repellant composition. The core polymer in such a configuration may serve to impart strength and stability to the drawn fibers.

The drawn filaments may then be laid onto a moving belt or screen to form a web, wherein the filaments may be laid in a manner to control the size of the open spaces between the fibers. The filaments and filament strands may be randomly distributed within the angular range of the substrate plane. Once a web is formed, the web may then be bonded by a number of methods such as point bonding, RSS/flat calendering, ultrasonic bonding, hydroentangling, needlepunching, etc. Bonding may occur along discrete locations across the surface or edges of the fabric. In addition, bonding may be performed to form various patterns across the surface of the fabric. It may therefore be appreciated that the manner in which the filaments are laid onto the belt, as well as fiber denier, may be adjusted to regulate the openings and porosity of the resulting formed web.

The nonwoven material herein may offer advantages of woven and knit structures used for insect barrier nets. The net may form a light-weight, high-strength, air permeable substrate. A description of the representative properties of the contemplated nonwoven material used for insect barrier applications follows herein.

The resulting nonwoven material may be in the range of 5-50 grams per square meter (gsm), including all values and increments therein such as 15-30 gsm, 19 gsm, etc. In addition, the fabric may have a thickness, as measured using ASTM D1777, in the range of 0.05 mm to 1.0 mm, including all values and increments therein such as 0.12 mm, 0.15 mm, etc. The maximum apparent size openings between the fibers may be within 1 micron to 5 mm in any given direction, including all values and increments therein, such as 0.5 to 1.0 mm, 0.7 mm, etc. In addition, the nonwoven material may also have air permeability in the range of 1500 to 15000 l/m²/sec, including all values and increments therein such as 5000 l/m²/sec.

The nonwoven material may also have a grab tensile strength in the machine direction of 20 N to 100 N, including all values and increments therein, such as 38 N, 47 N, etc., and a grab tensile strength in the transverse direction of 20 N to 100 N, including all values and increments therein, such as 33 N, 38 N, etc., as measured by ASTM D5034. In addition, the nonwoven material may have a grab tensile elongation in the machine direction in the range of 10 to 60%, including all values and increments therein, such as 20%, 30%, etc., and a grab tensile elongation in the cross direction in the range of 10 to 60% including all values and increments therein, such as 30%, 25%, etc., as measured by ASTM D5035.

Furthermore, the nonwoven material may have a trapezoidal tear strength in the machine direction in the range of 10 to 40 N, including all values and increments therein, and a trapezoidal tear strength in the cross direction in the range of 10 to 40 N, including all values and increments therein, as measured by ASTM D1117. The nonwoven material may also be characterized as having a Mullen burst strength, as measured by ASTM D3786, in the range of 100 to 300 kPa, including all values and increments therein.

In a further exemplary embodiment, perforations may optionally be formed in the web via thermal or mechanical means such as calendering, needlepunching, hydroentangling, die cutting, other puncturing methods or searing. For example, by an exemplary method of calendering, point bond calendering may be used under high pressure and temperature to create uniform holes in size and placement across the surface of the fabric. The perforations may be formed while bonding of the fabric or after bonding of the fabric.

The perforations may also be formed in a continuous or staple filament spun web by hydroentangling the web over a mesh belt to create holes of uniform size across the surface of the fabric. Once again, hydroentangling may be performed during bonding or after bonding. The perforations may maintain a maximum approximate size opening in the range of 0.1 mm to 5 mm, including all values and increments therein. It may therefore be appreciated that the net may include an apparent size opening between the fibers of, as noted above, about 1 micron to 5 mm in any given direction, as well as perforations in the range of 0.1 mm to 5 mm. It may be appreciated that the size of the perforations may aid in controlling air porosity.

In another exemplary embodiment, the net may be formed from at least one spunbond web and another spunbond web having varying characteristics or another web type, such as meltblown web, flashspun web, fibrillated film, carded web, needlepunched web, etc. For example, a SMS or spunbond/meltblown/spunbond composite may be provided. In addition, the fibers forming the webs may be continuous or staple. The spunbond may be bonded to another web by mechanical, thermal, ultrasonic or chemical methods, such as needlepunching, hydroentangling, air through bonding, or calendering of either all or a portion of the fabric surface area including point or pattern bonding, irradiation (IR), as well as impregnation of an adhesive, foam application, spray, padding, etc. Once again, such structures may be perforated, if desired, while bonding or after bonding the webs.

In yet a further exemplary embodiment, an insect repellant composition may be disposed on or incorporated within the nonwoven or fibers. Disposed on may be understood herein as application of the insect repellent to a net by, for example, immersing a net in insect repellent, spraying a net with insect repellent, or otherwise applying the insect repellent to a net such that insect repellent may be present on the nonwoven or fibers. In some situations, the insect repellent may bind to the fibers either chemically or mechanically. Incorporated within the nonwoven or fibers may be understood herein as the incorporation of the insect repellent into a portion of the fiber other than the fiber surface. For example, “within” may be understood to be located at a region below the surface and dispersed through-out the fiber cross-section.

The insect repellant composition may be understood herein to include an insecticide as an active ingredient and optionally a binding agent. The binding agent may serve to improve the adhesion of the insect repellant composition onto the fibers of the nonwoven material. In particular, the sheath polymer in the sheath/core configuration described previously may create a binding site for the binding agent to affix the insect repellant to the fiber on the nonwoven material. Further, depending on the method of application, i.e. padding, spraying or foam application, additional additives may be incorporated into the insect repellant composition to promote ease of manufacture during application, such as defoamers and or fillers. Exemplary insecticides (i.e. insect repellants) may include pyrethoids such as alphacypermethrin, cyfluthrin, deltamethrin, etofenprox, or lambda-cyhalothrin; carbamates such as bendiocarb or propoxur; organophosphates such as fenitrothion, malathion, pirimiphos-methyl; or organochlorine such as DDT.

The insect repellant compositions may be applied via various coating methods, such a spray, pad or dip coating. In addition, the insecticides may be incorporated into slow release coatings which may be applied to the nonwoven. Further, the insect barrier net may be formed into a net or tent-like structure and the insect repellant composition may then be applied in finished product form. The insect repellant may be applied at levels not less than 25 mg per square meter of nonwoven material. For example, an insect repellant, such as deltamethrin may be applied to nonwoven material at levels no less than 25 mg per square meter of nonwoven material. In yet another exemplary embodiment, an insect repellant, such as alphacypermethrin may be applied to a nonwoven structure at a level of at least 25 mg per square meter of nonwoven material. In yet another exemplary embodiment, an insect repellant, such as lambda-cyhalothrin may be applied to a nonwoven structure at a level of at least 25 mg per square meter of nonwoven material. Still, another embodiment, a carbamate insect repellant such as bendiocarb or propoxur may be applied to a nonwoven structure at a level of at least 25 mg per square meter of nonwoven material. In yet another embodiment, organophosphates insect repellants, such as fenitrothion, malathion, pirimiphos-methyl may be applied to a nonwoven structure at a level of at least 25 mg per square meter of nonwoven material. In yet another embodiment, an organochlorine insect repellant such as DDT, may be applied to a nonwoven structure at a level of at least 25 mg per square meter of nonwoven material.

The nonwoven materials may be formed or fashioned into a net suitable for draping over a sleeping area. In such a manner, one or more circular rings, hooks, or ties may be affixed to the fabric to hang the fabric from a ceiling, surface, pole, etc. The hooks or ties may be formed from a suitable metal, plastic or fabric material that may be affixed to the net material. A reinforcing material may be utilized in the region where the hook or tie is provided, which may therefore prevent tearing of the fabric. In addition, the nets may incorporate an elasticized portion or portions to hug the net to a mat, mattress, or other sleeping area. In such a manner, the elasticized portion may be sewn or otherwise bonded around the net. Furthermore, pockets may be provided along the net surface to incorporate support structures such as flexible poles of metal, wood or other suitable material.

To further describe the invention, attention is turned FIGS. 1 through 4, which include non-limiting examples of the nets contemplated herein. Referring to FIG. 1, the nonwoven material (12) may be manufactured as described herein. The nonwoven material (12) may be formed into a rectangular nonwoven insect barrier net (10). In this example, the nonwoven material (12) may be sewn together to form an insect barrier net (10) with a top and four sides. The height of the insect barrier net may be 150-cm. However, it should be appreciated that various net heights may be contemplated herein, such as 50 to 200 cm, including all values and increments therein. The length and width of the insect barrier net may be 180-cm and 160-cm, respectively. Once again, it should be appreciated that various lengths and widths may be contemplated herein. In this particular embodiment, four circular metal rings (14), each ¾″ diameter, may be attached to each corner, and in the relative center, along the top of the nonwoven insect barrier net (10). Referring to FIG. 2, a top elevation view shows the nonwoven insect barrier net (10), wherein the nonwoven material (12) forms the four sides and top of the insect barrier net (10). In addition, the circular rings (14) may be used to hang the insect barrier net over a sleeping surface. The insect barrier net may then be combined with a long-lasting insecticide, such as Interceptor® available from BASF Ag.

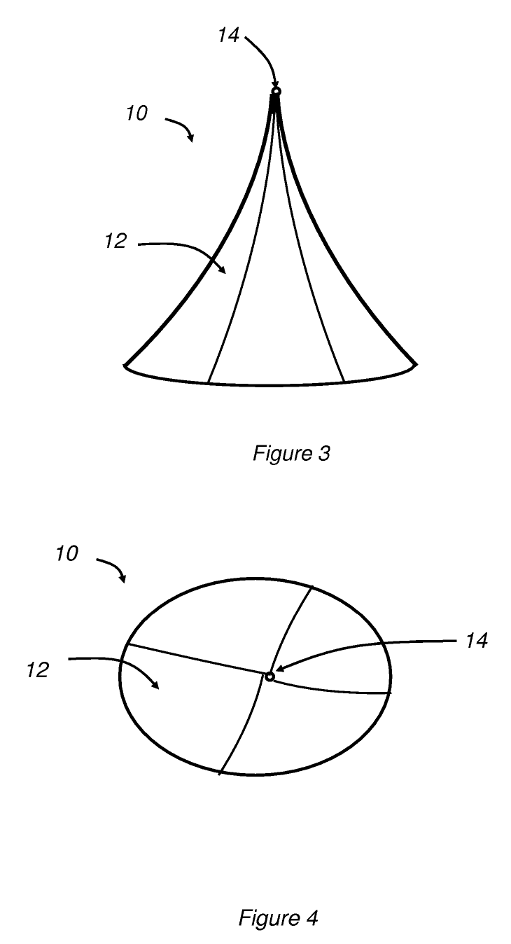

Referring to FIG. 3, a conical type net structure is shown. The nonwoven material (12) may be manufactured as described herein. The nonwoven material (12) may be formed into a conical nonwoven insect barrier net (10). In this example, the nonwoven material (12) may be sewn together to form an insect barrier net (10). The height of the insect barrier net may be 150-cm, (once again, such height may be varied). The diameter of the insect barrier net may be 180-cm, (this dimension may be varied as well). In this particular embodiment, a single circular metal ring (14), ¾″ diameter, may be attached to each top of the nonwoven insect barrier net (10). Referring to FIG. 4, a top elevation view shows the nonwoven insect barrier net (10), wherein the nonwoven material (12) form the sides of a conical insect barrier net (10). In addition, the circular ring (14) may be used to hang the insect barrier net over a sleeping surface. The insect barrier net may then be combined with a long-lasting insecticide, such as Interceptor® available from BASF Ag.

The following examples are presented herein to illustrate the present disclosure and are not intended to limit the scope of the invention, the following exemplary embodiments may be used to further as further description thereof.

### EXAMPLE A

In a first non-limiting example, six (6) denier sheath/core co-polyester/polyester filaments were formed and deposited in random arrangement to create a spunbond nonwoven. The filaments were point sealed using calendar rolls to bond the filaments together and impart structural integrity. The spunbond nonwoven had a basis weight of 20 g/m². Samples were then tested to evaluate strength, thickness, bursting strength, air permeability and apparent pore size opening. The values reported were as follows:

| Physical Property | Test Method | Units | Value |
|---|---|---|---|
| Basis Weight | ASTM D6242 | g/m² | 20 |
| Thickness | ASTM D1777 | mm | 0.15 |
| Grab Tensile (MD) | ASTM D5034 | N | 38 |
| % Elongation at Break (MD) | ASTM D5035 | % | 30 |
| Grab Tensile (CD) | ASTM D5034 | N | 33 |
| % Elongation at Break (CD) | ASTM D5035 | % | 28 |
| Trapezoidal Tear (CD) | ASTM D117 | N | 17 |
| Air Permeability | ASTM D747 | l/m²/sec | 4915 |
| Apparent Pore Size Opening | Modified | mm | 1.18 |
| Mullen Burst | ASTM D3786 | kPa | 144 |

The spunbond nonwoven was then formed into a nonwoven insect barrier net. The nonwoven material was sewn together to form an insect barrier net as shown in FIG. 1. The height of the insect barrier net was 150-cm. The length and width of the insect barrier net was 180-cm and 160-cm, respectively. Five (5) circular metal rings, each ¾″ diameter, were attached to each top corner and the center of the top portion of the nonwoven insect barrier net. The circular rings were used to hang the insect barrier net over a sleeping surface. The insect barrier net was then combined with a long-lasting insecticide K-O TAB® 1-2-3 available from Bayer Corp.

### EXAMPLE B

In a second non-limiting example, six (6) denier sheath/core co-polyester/polyester filaments were formed and deposited in random arrangement to create a spunbond nonwoven. The filaments were flat-calendar bonded to impart structural integrity. The spunbond nonwoven had a basis weight of 20 g/m². Samples were then tested to evaluate strength, thickness, bursting strength, air permeability and apparent pore size opening. The values reported were as follows:

| Physical Property | Test Method | Units | Value |
|---|---|---|---|
| Basis Weight | ASTM D6242 | g/m² | 20 |
| Thickness | ASTM D1777 | mm | 0.12 |
| Grab Tensile (MD) | ASTM D5034 | N | 47 |
| % Elongation at Break (MD) | ASTM D5035 | % | 21 |
| Grab Tensile (CD) | ASTM D5034 | N | 33 |
| % Elongation at Break (CD) | ASTM D5035 | % | 31 |
| Trapezoidal Tear (CD) | ASTM D117 | N | 16 |
| Mullen Burst | ASTM D3786 | PSI | 25.8 |
| Air Permeability | ASTM D747 | l/m²/sec | 4953 |
| Apparent Pore Size Opening | Modified | mm | 0.71 |
| Mullen Burst | ASTM D3786 | kPa | 178 |

The spunbond nonwoven was then formed into a nonwoven insect barrier net (10). The nonwoven material was sewn together to form an insect barrier net as shown in FIG. 1. The height of the insect barrier net was 150-cm. The length and width of the insect barrier net was 180-cm and 100-cm, respectively. Five circular metal rings, each ¾″ diameter, were attached to each corner and the center of the top of the nonwoven insect barrier net. The circular rings were used to hang the insect barrier net over a sleeping surface. The insect barrier net was then combined with a long-lasting insecticide Interceptor® available from BASF Ag.

### EXAMPLE C

In a yet another non-limiting example, seven (7) denier sheath/core co-polyester/polyester filaments were formed and deposited in random arrangement to create a spunbond nonwoven. The filaments were flat-calendar bonded to impart structural integrity. The spunbond nonwoven had a basis weight of 25-g/m². Samples were then tested to evaluate strength, thickness, bursting strength and air permeability. The values reported were as follows:

| Physical Property | Test Method | Units | Value |
|---|---|---|---|
| Basis Weight | ASTM D6242 | g/m² | 25 |
| Thickness | ASTM D1777 | mm | 0.13 |
| Grab Tensile (MD) | ASTM D5034 | N | 75 |
| % Elongation at Break (MD) | ASTM D5035 | % | 45 |
| Grab Tensile (CD) | ASTM D5034 | N | 75 |
| % Elongation at Break (CD) | ASTM D5035 | % | 50 |
| Trapezoidal Tear (CD) | ASTM D117 | N | 30 |
| Air Permeability | ASTM D747 | l/m²/sec | 4085 |
| Mullen Burst | ASTM D3786 | kPa | 234 |

The spunbond nonwoven was then formed into a nonwoven insect barrier net. The spunbond nonwoven was sewn together to form a conical insect barrier net as shown in FIG. 3. The height of the insect barrier net was 150-cm. The diameter of the base of the insect barrier net was 180-cm. In this particular embodiment one circular metal ring, ¾″ diameter, was attached to the top of the nonwoven insect barrier net. The circular rings are used to hang the insect barrier net over a sleeping surface. The insect barrier net was then combined with a long-lasting insecticide Interceptor® available from BASF Ag.

### EXAMPLE D

In a yet another non-limiting example, sever (7) denier sheath/core co-polyester/polyester filaments were formed and deposited in random arrangement to create a spunbond nonwoven. The filaments were then flat-calendar bonded to impart structural integrity. The spunbond nonwoven had a basis weight of 30 g/m². Samples were then tested to evaluate strength, thickness, air permeability and apparent pore size opening. The values reported were as follows:

| Physical Property | Test Method | Units | Value |
|---|---|---|---|
| Basis Weight | ASTM D6242 | g/m² | 30 |
| Thickness | ASTM D1777 | mm | 0.15 |
| Grab Tensile (MD) | ASTM D5034 | N | 100 |
| % Elongation at Break (MD) | ASTM D5035 | % | 45 |
| Grab Tensile (CD) | ASTM D5034 | N | 100 |
| % Elongation at Break (CD) | ASTM D5035 | % | 50 |
| Trapezoidal Tear (CD) | ASTM D117 | N | 35 |
| Air Permeability | ASTM D747 | l/m²/sec | 2699 |
| Mullen Burst | ASTM D3786 | kPa | 279 |

### EXAMPLE E

In a yet another non-limiting example, four (4) denier sheath/core co-polyester/polyester filaments were formed and deposited in random arrangement to create a spunbond nonwoven. Point sealed calendar rolls were used to bond the filaments and impart structural integrity. The spunbond nonwoven had a basis weight of 17 g/m². Samples were then tested to evaluate strength, thickness and air permeability. The values reported were as follows:

| Physical Property | Test Method | Units | Value |
|---|---|---|---|
| Basis Weight | ASTM D6242 | g/m² | 17 |
| Thickness | ASTM D1777 | mm | 0.13 |
| Grab Tensile (MD) | ASTM D5034 | N | 45 |
| % Elongation at Break (MD) | ASTM D5035 | % | 38 |
| Grab Tensile (CD) | ASTM D5034 | N | 45 |
| % Elongation at Break (CD) | ASTM D5035 | % | 45 |
| Trapezoidal Tear (CD) | ASTM D117 | N | 17 |
| Air Permeability | ASTM D747 | l/m²/sec | 2928 |
| Mullen Burst | ASTM D3786 | kPa | 144 |

### EXAMPLE F

In a yet another non-limiting example, six (6) denier sheath/core co-polyester/polyester filaments were formed and deposited in random arrangement to create a spunbond nonwoven. Point sealed calendar rolls were used to bond the filaments and impart structural integrity. The spunbond nonwoven had a basis weight of 30 g/m². Samples were then tested to evaluate strength, thickness and air permeability. The values reported were as follows:

| Physical Property | Test Method | Units | Value |
|---|---|---|---|
| Basis Weight | ASTM D6242 | g/m² | 30 |
| Thickness | ASTM D1777 | mm | 0.18 |
| Grab Tensile (MD) | ASTM D5034 | N | 84 |
| % Elongation at Break (MD) | ASTM D5035 | % | 44 |
| Grab Tensile (CD) | ASTM D5034 | N | 82 |
| % Elongation at Break (CD) | ASTM D5035 | % | 56 |
| Trapezoidal Tear (CD) | ASTM D117 | N | 30 |
| Air Permeability | ASTM D747 | l/m²/sec | 1733 |
| Mullen Burst Strength | ASTM D3786 | kPa | 153 |

A comparative example of a polyester warp knitted insect barrier net, Permenat®, provides the following physical properties.

| Physical Property | Test Method | Units | Value |
|---|---|---|---|
| Basis Weight | ASTM D6242 | g/m² | 17 |
| Thickness | ASTM D1777 | mm | 19 |
| Grab Tensile (MD) | ASTM D5034 | N | 27 |
| % Elongation at Break (MD) | ASTM D5035 | % | 10 |
| Grab Tensile (CD) | ASTM D5034 | N | 34 |
| % Elongation at Break (CD) | ASTM D5035 | % | 34 |
| Trapezoidal Tear (CD) | ASTM D117 | N | 22 |
| Air Permeability | ASTM D747 | l/m²/sec | 11450 |
| Apparent Pore Size Opening | Modified | mm | 2 |
| Mullen Burst Strength | ASTM D3786 | kPa | 220 |

It may be appreciated that of the examples described, Example E demonstrated improvements in tensile strength, tear strength and mullen burst strength over a the comparative knitted insect barrier while still exhibiting acceptable air permeability. Example A, while maintaining a light basis weight, displayed improvements in tensile strength while achieving acceptable air permeability and substantially smaller pore size opening. The other examples also illustrated various improvements in selected properties over the comparative example. It is also noted that Example A and E displayed an affinity with pyrethoid insecticides.

The foregoing description is provided to illustrate and explain the disclosure herein. However, the description hereinabove should not be considered to limit the scope of the invention set forth in the claims appended hereto.

What is claimed is:

1. An insect barrier net, comprising:
a nonwoven including fibers having a denier less than 50, wherein said nonwoven material has an air permeability of at least 1500 l/m²/second; and
an insect repellant disposed on or incorporated in said fibers.

2. The insect barrier net of claim 1, wherein said nonwoven has a machine direction grab tensile strength of at least 20 N.

3. The insect barrier net of claim 1, wherein said nonwoven has a basis weight less than 50 grams per square meter.

4. The insect barrier net of claim 1, wherein said nonwoven comprises polyester/co-polyester bicomponent fibers.

5. The insect barrier net of claim 1, wherein said insect repellant comprises deltamethrin applied to said nonwoven at a level of at least 25 mg per square meter of said nonwoven.

6. The insect barrier net of claim 1, wherein said insect repellant comprises alphacypermethrin applied to said nonwoven at a level of at least 25 mg per square meter of said nonwoven.

7. The insect barrier net of claim 1, wherein said insect repellant comprises lambda-cyhalothrin applied to said nonwoven at a level of at least 25 mg per square meter of said nonwoven.

8. The insect barrier net of claim 1, wherein said fibers comprise polyethylene fibers.

9. The insect barrier net of claim 1, wherein said fibers comprise polyamide fibers.

10. The insect barrier net of claim 1, wherein said nonwoven has an apparent pore size opening less than 5-mm.

11. A nonwoven insect barrier net, comprising:
a nonwoven with a basis weight of less than 50 grams per square meter, said nonwoven having an air permeability at least 1500 l/m²/second and including bicomponent fibers with a denier less than 50; and
an insect repellant composition disposed on or incorporated in said fibers.

12. The nonwoven insect barrier net of claim 11, wherein said bicomponent fibers includes a sheath polymer and a core polymer, wherein said sheath polymer is a binding site for said insect repellant composition.

13. The nonwoven insect barrier net of claim 12, wherein said sheath polymer is co-polyester and said core polymer is polyester.

14. The nonwoven insect barrier net of claim 11, wherein said bicomponent fibers comprise polyester and polyamide.

15. The nonwoven insect barrier net of claim 11, wherein said bicomponent fibers comprise polyester and polyethylene.

16. The nonwoven insect barrier net of claim 11, wherein said nonwoven has machine direction grab tensile strength of at least 20 N.

17. The nonwoven insect barrier net of claim 11, wherein said insect repellent composition comprises an active ingredient and a binding agent.

18. The insect barrier net of claim 17, wherein said active ingredient is organochlorine.

19. The nonwoven insect barrier net of claim 17, wherein said active ingredient is deltamethrin.

20. The insect barrier net of claim 17, wherein said active ingredient is alphacypermethrin.

21. A method of making a nonwoven insect barrier net material comprising:
providing fibers with a denier less than 50;
depositing said fibers on a moving belt forming a nonwoven with a basis weight less than 50 g/m²;
bonding said nonwoven using heat and pressure;
collecting said nonwoven;
forming said nonwoven into a nonwoven insect barrier net; and
applying an insect repellent composition to said nonwoven insect barrier net.

22. A nonwoven insect barrier net, comprising:
a nonwoven including bicomponent fibers, said fibers having a denier of less than 10, wherein said nonwoven has a basis weight of less than 50 grams per square meter, an air permeability of at least 2000 l/m²/second and an apparent pore size opening less than 5 mm; and
deltamethrin disposed on or incorporated in said fibers at a level of at least 25 mg per square meter of said nonwoven.
